(19) United States
(12) Patent Application Publication
(10) Pub. No.: US 2012/0265809 A1
(43) Pub. Date: Oct. 18, 2012

(54) TRANSFERRING INFORMATION FROM AN AUTOMATED TELLER MACHINE (ATM) TO MOBILE COMMUNICATION DEVICE DURING A USER INTERACTION SESSION

(75) Inventors: Carrie Anne Hanson, Charlotte, NC (US); Matthew A. Calman, Charlotte, NC (US)

(73) Assignee: BANK OF AMERICA CORPORATION, Charlotte, NC (US)

(21) Appl. No.: 13/088,181

(22) Filed: Apr. 15, 2011

(51) Int. Cl. G06F 15/16

(52) U.S. Cl. 709/204

(57) ABSTRACT

Embodiments of the invention provide for wirelessly communicating information from an ATM to a customer's mobile communication device during or proximate in time with the customer's ATM interaction session. More specifically, the information is accessible to the customer through communication of a Uniform Resource Locator (URL) that is wirelessly communicated from the ATM to the customer's mobile communication device. In specific embodiments, the URL may be associated with customer-specific information that is determined, on-the fly during the ATM interaction session, based on customer inputs during the session and/or customer profile data, including transaction history data. In other specific embodiments, the URL may be associated with financial institution contact information, such that the customer may obtain answers to questions related to the ATM interaction session or any other financial institution-related matter using their mobile communication device.

### FIELD

In general, embodiments of the invention relate to financial institution interactions and, more particularly, to seamlessly transferring information from an Automated Teller Machine (ATM) to a mobile communication device during or proximate to a user interaction session.

### BACKGROUND

Automated Teller Machines (ATMs) have become the predominant banking channel for the vast majority of customer transactions, especially cash withdrawals, cash/checking deposits or account balance inquiries. Currently, customers may conduct banking transactions, such as cash withdrawals, cash/checking deposits, account transfers, balance inquiries and the like, at an ATM. However, in most instances an ATM is limited in terms of its output capabilities to dispensing cash and providing a receipt which details the transactions and may include account balances. As ATMs become more advanced in terms of their capabilities, the need becomes more apparent to develop ATMs that have the ability to expand on their output capabilities and communicate with the customer in other forms.

While traditional ATM transactions, such as those listed above, can typically be conducted in a relatively short period time, other burgeoning activities, such as product/account enrollment, investment transactions and the like have a tendency to be more complex and time-consuming endeavors. If the customer desires to pursue a lengthy transaction at an ATM, all too often it is to the detriment of other customers waiting to use the ATM. Additionally, the more complex the activity or transaction tends to be the more likely the customer will need to rely on contacting or interfacing with bank associates in order to have their questions answered or to further completion of the activity/transaction. Invariably, the need to contact the bank during an ATM activity/transaction adds more time to the customer's involvement with the ATM.

Therefore, a need exists to develop systems, methods, computer program products and the like for expanding the output capabilities of ATMs, such that customers may acquire information from the ATM during the ATM interaction session or shortly thereafter. In such desired embodiments, the customer benefits from obtaining information not otherwise readily available from an ATM. Moreover, in other desired embodiments, in which the information may be available to the customer during the session but such availability seriously impacts the length of the customer's use of the ATM, the financial institution benefits from the ATM becoming available for other customer use sooner than it would otherwise.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. The summary's sole purpose is to present some concepts of one or more embodiments in a simplified form as a prelude to the more detailed description that is presented later.

Thus, further details are provided below for methods, apparatus and computer-program products that provide for wirelessly communicating information from an ATM to a customer's mobile communication device during or proximate to the customer's ATM interaction session. More specifically, the information is accessible to the customer through communication of a Uniform Resource Locator (URL) that is wirelessly communicated from the ATM to the customer's mobile communication device. In specific embodiments, the URL may be associated with customer-specific information that is determined, on-the fly during the ATM interaction session, based on customer inputs during the session and/or customer profile data, including transaction history data. Such customer-specific information may include, but is not limited to, offers, coupons, discounts or the like. In other specific embodiments, the URL may be associated with financial institution contact information, such that the customer may obtain answers to questions related to the ATM interaction session or any other financial institution-related matter using a different channel other than the ATM, specifically their mobile communication device.

Such embodiments of the present invention expand the output capabilities of the ATM beyond dispensing cash and an associated transaction receipt. Customers can instantaneously obtain information related to the ATM interaction session without having to manually write down the information or otherwise remember the information. In instance in which the information obtained is related to the user's interaction session at the ATM, receiving the information on the customer's mobile device as opposed to the ATM, may shorten the length of time that the customer interacts with the ATM, thus making the ATM available for a waiting customer.

A method defines first embodiments of the invention. The method includes initiating a user interaction session at an Automated Teller Machine (ATM) and communicating, from the ATM to a user's mobile communication device during or proximate in time to the user interaction session, a Uniform Resource Locator (URL) that provides network access to information associated with the user interaction session.

In specific embodiments the method further comprises determining user-specific information based on user inputs received during the user interaction session and/or based on retrieved user profile data, including transaction history data or the like. In such embodiments of the method, communicating further comprises communicating, from the ATM to the user's mobile communication device during or proximate in time with the user interaction session, the URL that provides network access to the user-specific information.

In other specific embodiments the method includes automatically activating the URL, upon receipt by the user's mobile communication device, to provide network access to the information. While in other related embodiments of the method, the user of the mobile communication device may choose to activate the URL upon receipt or the user may choose to store the URL in mobile communication device memory for subsequently accessing the information at a later point in time.

In still further specific embodiments of the method, communicating further includes communicating, from the ATM to a user's mobile communication device during or proximate in time with the user interaction session, the URL that provides network access to the information, wherein the information is associated with an offer, discount, coupon or the like. In specific embodiments of the method, the offer, discount, coupon or the like may be a user-specific offer/discount/coupon or the like determined based on user inputs provided during the session or based on user profile data, including transaction history.

In other specific embodiments of the method communicating further includes communicating, from the ATM to a user's mobile communication device during or proximate in time with the user interaction session, the URL that provides network access to the information, wherein the information is associated with financial institution contact information. In such embodiments of the invention the URL or some other communicated information may provide for automatically dialing a contact-related telephone number associated with the financial institution. In other embodiments of the method, the financial institution contact information may be a contact page on the financial institution's website or the like.

In additional specific embodiments of the method, communicating further includes communicating, from the ATM to a user's mobile communication device during or proximate in time with the user interaction session, information associated with the user interaction session, wherein communicating is implemented by one of Near Field Communication (NFC), Bluetooth®, Short Message Service (SMS), zigbee or 802.11 wireless protocol.

In other specific embodiments of the method communicating further includes presenting a visually readable code on a display associated with the ATM, wherein the code includes the URL that provides access to the information and capturing the code with the mobile communication device. In such embodiments of the method, the visually readable code may be one of a bar code, a Quick Response (QR) code, or Secure Quick Response (SQR) code.

A system defines second embodiments of the invention. The system includes an Automated Teller Machine (ATM) including a first computing platform having a first memory and a first processor in communication with the first memory. The first processor is configured to initiate a user interaction session and communicate, during or proximate in time with the user interaction session, a Uniform Resource Locator (URL) that provides network access to information associated with the user interaction session. The system additionally includes a mobile communication device including a second computing platform having a second memory and a second processor in communication with the second memory. The second processor is configured to receive the URL from the ATM during or proximate in time with the user interaction session.

In specific embodiments of the system the first processor of the ATM is further configured to determine user-specific information based on user inputs received during the user interaction session and/or based on retrieved user profile data, such as transaction history data or the like. In such embodiments the first processor is further configured to communicate, during or proximate in time with the user interaction session, the URL that provides network access to the user-specific information.

In other specific embodiments of the system, the second processor of the mobile communication device is further configured to automatically activate the URL, upon receipt, to provide network access to the information. While in other related embodiments of the system, the second processor of the mobile communication device is further configured choose to receive a user input to activate the URL upon receipt or configured to receive another user input that stores the URL in mobile communication device memory for subsequently accessing of the information at a later point in time.

In still further specific embodiments of the system, the information that is accessed via the URL is associated with an offer, discount, coupon or the like. In specific embodiments of the method, the offer, discount, coupon or the like may be a user-specific offer/discount/coupon or the like determined based on user inputs provided during the session or based on user profile data, including transaction history.

In other specific embodiments of the system, the information that is accessed via the URL, is associated with financial institution contact information. In such embodiments of the invention the URL or some other communicated information may provide for automatically dialing a contact-related telephone number associated with the financial institution. In other embodiments of the method, the financial institution contact information may be a contact page on the financial institution's website or the like.

In still further embodiments of the system, communication of the URL from the ATM to the mobile communication device may be implemented by any known or future known wireless communication mechanism, including, but not limited to, Near Field Communication (NFC), Bluetooth®, zigbee or 802.11 wireless protocol. In other related embodiments of the system, the first processor of the ATM is further configured to present a visually readable code on a display associated with the ATM, wherein the code includes the URL that provides access to the information and the mobile. In such embodiments of the system, the visually readable code may be one of a bar code, a Quick Response (QR) code, or Secure Quick Response (SQR) code.

A computer program product defines third embodiments of the invention. The computer program product includes a non-transitory computer-readable medium. The computer-readable medium includes a first set of codes for causing a computer to initiate a user interaction session at an Automated Teller Machine (ATM) and a second set of codes for causing a computer to communicate, from the ATM to a user's mobile communication device during the user interaction session, a Uniform Resource Locator (URL) that provides network access to information associated with the user interaction session.

Thus, further details are provided below for methods, apparatus and computer-program products that provide for communicating information from an ATM to a customer's mobile communication device during or proximate in time with the customer's ATM interaction session. More specifically, the information is accessible to the customer through communication of a Uniform Resource Locator (URL) that is wirelessly communicated from the ATM to the customer's mobile communication device. In specific embodiments, the URL may be associated with customer-specific information that is determined, on-the fly during the ATM interaction session, based on customer inputs during the session and/or customer profile data, including transaction history data. In other specific embodiments, the URL may be associated with financial institution contact information, such that the customer may obtain answers to questions related to the ATM interaction session or any other financial institution-related matter using a different channel other than the ATM, specifically their mobile communication device.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference may now be made to the accompanying drawings:

FIG. 1 is a schematic diagram of a system for communicating a interaction session-related URL from an Automated Teller Machine (ATM) to a user's mobile communication device, in accordance with embodiments of the present invention;

FIG. 2 is a block diagram of a system for communicating a interaction session-related URL from an Automated Teller Machine (ATM) to a user's mobile communication device, in accordance with embodiments of the present invention;

FIG. 3 is a block diagram of a system for transferring a user interaction session from an Automated Teller Machine (ATM) to a user's mobile communication device, in accordance with embodiments of the present invention; and

FIG. 4 is a flow diagram of a method for communicating an interaction session-related URL from an Automated Teller Machine (ATM) to a user's mobile communication device, in accordance with present embodiments of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As may be appreciated by one of skill in the art, the present invention may be embodied as a method, system, computer program product, or a combination of the foregoing. Accordingly, the present invention may take the form of an entirely software embodiment (including firmware, resident software, micro-code, etc.) or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, or semiconductor system, apparatus, device, or propagation medium. More specific examples of the computer readable medium include, but are not limited to, the following: a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Computer program code for carrying out operations of embodiments of the present invention may be written in an object oriented, scripted or unscripted programming language such as Java, Perl, Smalltalk, C++, SAS or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, methods, apparatus and computer-program products are described in detail below that provide for wirelessly communicating information from an ATM to a customer's mobile communication device during or proximate in time with the customer's ATM interaction session. More specifically, the information is accessible to the customer through communication of a Uniform Resource Locator (URL) that is wirelessly communicated from the ATM to the customer's mobile communication device. In specific embodiments, the URL may be associated with customer-specific information that is determined, on-the fly during the ATM interaction session, based on customer inputs during the session and/or customer profile data, including transaction history data. Such customer-specific information may include, but is not limited to, offers, coupons, discounts or the like. In other specific embodiments, the URL may be associated with financial institution contact information, such that the customer may obtain answers to questions related to the ATM interaction session or any other financial institution-related matter using a different channel other than the ATM, specifically their mobile communication device.

Such embodiments of the present invention expand the output capabilities of the ATM beyond dispensing cash and an associated transaction receipt. Customers can instantaneously obtain information related to the ATM interaction session without having to manually write down the information or otherwise remember the information. In instance in which the information obtained is related to the user's interaction session at the ATM, receiving the information on the customer's mobile device as opposed to the ATM, may shorten the length of time that the customer interacts with the ATM, thus making the ATM available for a waiting customer.

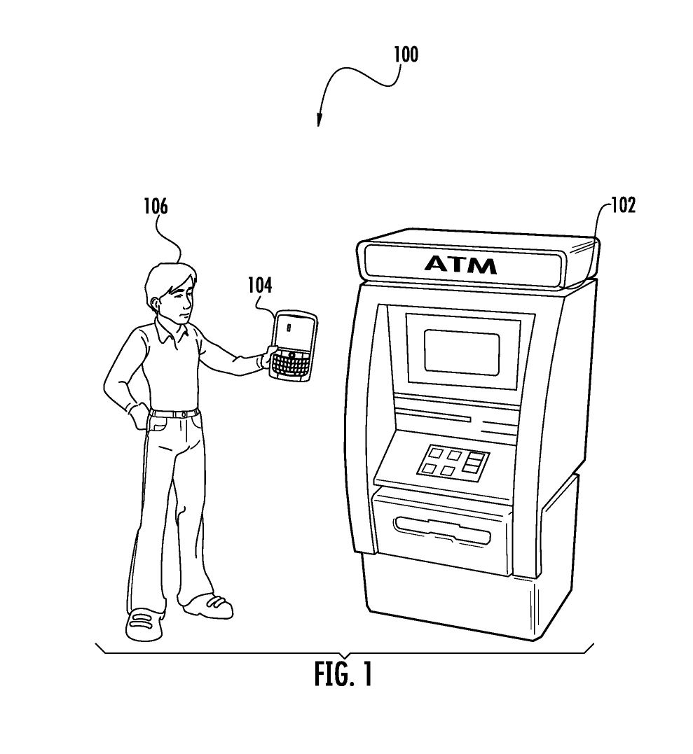

FIG. 1 is a schematic diagram of a system 100 for communicating from an Automated Teller Machine (ATM) 102 to a mobile communication device 104 in the possession of the user/customer 106, a Uniform Resource Locator that provides network access to information associated with the user interaction session. The ATM 102 as used and claimed herein includes conventional ATMs, Video Teller Machines (VTMs), kiosks or any other automated computerized system at which a user/customer may conduct an interaction session. In addition, ATM 102 as used and claimed herein is not limited to the components, modules, applications and the like physically embodied in the ATM 102 but also includes the devices, storage/memory, applications, modules and the like that are network accessible to the ATM 102, such as the financial institution network associated with the ATM 102. The mobile communication device 104 as used herein includes any smart phone, personal digital assistant or any other device configured to receive wireless communication and, specifically wireless communication from the ATM 102. The user interaction session that is transferred from the ATM 102 to the mobile communication device 104 may include any transaction, activity, product/service enrollment, experience or the like that the customer is conducting or participating in on the ATM 102.

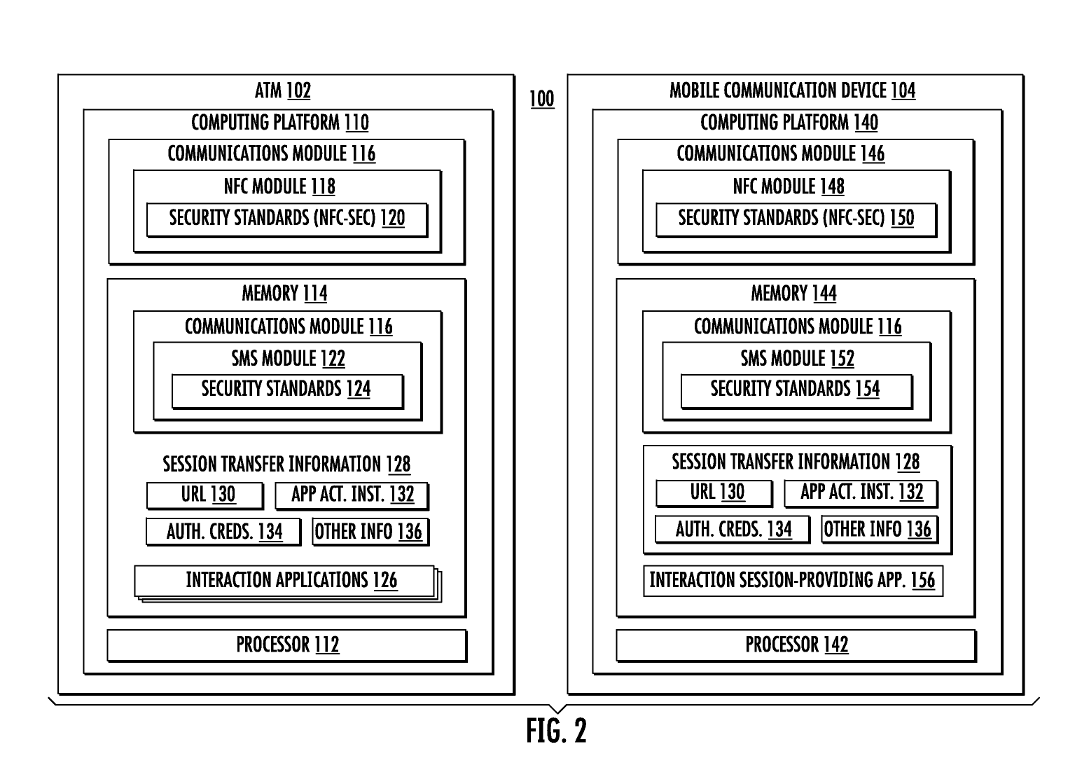

Referring to FIG. 2 a block diagram is depicted of a system 200 configured for communicating, from an ATM 102 to a mobile communication device 104, a Uniform Resource Locator (URL) that provides access to information associated with user interaction session implemented at the ATM 102, in accordance with embodiments of the present invention. The ATM 102 includes a computing platform 110 having at least one processor 112 and a memory 114 in communication with the processor. Memory 114 may be resident on ATM 102 or memory 114 may be remote memory that is network accessible to ATM 102, for example, memory 114 may reside on servers or the like as part of the financial institution's secure network. Memory 114 may comprise volatile and nonvolatile memory such as read-only and/or random-access memory (RAM and ROM), EPROM, EEPROM, or any memory common to computing platforms.

Processor 112 may be an application-specific integrated circuit (“ASIC”), or other chipset, processor, logic circuit, or other data processing device. Processor 112 or other processor such as an Application Specific Integrated Circuit (ASIC) may execute an application programming interface (“API”) layer (not shown in FIG. 2) that interfaces with any resident programs or modules.

Processor 112 may include various processing subsystems (not shown in FIG. 2) embodied in hardware, firmware, software, and combinations thereof, that enable the functionality of ATM 102 and the operability of the ATM 102 on a network, such as a secure financial institution network. For example, processing subsystems allow for initiating and maintaining communications, and exchanging data, with other networked devices. For the disclosed embodiments, processing subsystems of ATM 102 may include any subsystem used in conjunction with applications, modules, components and routines described herein.

In specific embodiments of the invention, the computing platform 110 of ATM 102 includes communication module 116 that is operable to communicate a URL 118 associated with the user interaction session implemented on the ATM 102. Since the information communicated from the ATM 102 to the mobile communication device is not generally considered private information, which would necessitate secure communication, the wireless communication means implemented by the communication module may include any known or future known communication mechanism. For example, the communication module may implement NFC, Bluetooth®, zigbee, RFID, 802.11/Wirless Local Area Network (WLAN) communication or the like. In addition, communication module 116 may implement a visually readable code, such as bar code, Quick Response (QR) code, Secure Quick Response (SQR) code or the like, as the means by which the URL 118 is communicated to the mobile communication device 104. In such embodiments of the system 100, the visually readable code is presented on a display (not shown in FIG. 2) of the ATM 102; in addition, the mobile communication device 102, is equipped with an image capturing mechanism 150, such as a still image camera or video camera, captures the image and decodes the image to result in the URL.

In specific embodiments of the invention, the URL 118 that is communicated from the ATM 102 to the mobile communication device provides network access of user/customer-specific information 120. In such embodiments of the invention, the memory 114 of ATM 102 includes user-specific information determining application 122 that is operable to determine user-specific information 120. The user/customer-specific information determining application 122 may be configured to determine the user-specific information 120 based on user inputs received during the interaction session at the ATM 102. For example, queries may be posed to the user/customer as part of the interaction session, such as queries related to product enrollment or the like or the queries may be unrelated to the interaction session and presented to the user/customer while a transaction is occurring. In other embodiments of the invention, the user/customer-specific information determining application 122 may be configured to determine the user-specific information 120 based on customer profile information including, but not limited to, historical transaction data. Customer profile information resides on financial institution network servers that are accessible to the ATM 102 during the user's interaction session. In such embodiments of the invention, in which user input and/or user profile information is implemented, the user/customer-specific information determining application 122 is configured to determine the user/customer-specific information 120 on the on-the-fly, during the interaction session.

In specific embodiments of the invention, the URL 118 that is generated and communicated from the ATM 102 to the mobile communication device 104 provides network access to offers, coupons, discounts or the like, collectively referred to herein as “offers” 124. The offers 124 may be associated with financial institution products or services or the offers 124 may be associated with third party-entities, such as retailers, service providers or the like, which may associated, affiliated or otherwise in a relationship with the financial institution. In further specific embodiments of the invention, the offers 124 that are accessible via the communicated URL 118 are user-specific offers 126. In such embodiments, the memory 114 of ATM 102 stores user-specific offer determining application 128 configured to generate user-specific offers 126. The user-specific offers 126 may be generated on-the-fly based on user inputs during the interaction session and/or based on customer profile information, including historical transaction data. Historical transaction data provides for identifying purchasing/transaction trends and the like, such that offers may be uniquely tailored to a user/customer based on their respective transaction history. In addition to the transaction history data, the geographic location of the ATM 102 may additionally be used to determine offers 124 for retailers, service providers or the like that are proximate in location to the ATM 102.

In still further specific embodiments of the invention, the URL 118 that is generated and communicated from the ATM 102 to the mobile communication device 104 provides network access to financial institution contact information 130, the contact information 130 may be direct contact in the form of telephone communication, video chat or the like or the contact information 130 may be indirect contact in the form of addresses, telephone numbers or the like provided via web pages or the like. In addition, “contact information” 130 as used herein may include answers to questions surrounding the interaction session, such as answers to questions related to a product enrollment or financial transaction. The contact information 130 may affirmatively be requested by the user/consumer during or shortly after the user interaction session or in alternate embodiments the contact information, such as a live video/audio chat or the like, may be suggested to the user/customer based inputs received and/or the time consumed in performing a session or a portion of the session.

The mobile communication device 104 includes a computing platform 140 having at least one processor 142 and a memory 144 in communication with the processor. The mobile communication device 104 includes computing platform 140 that can transmit data across a network, and that can receive and execute routines and applications. Computing platform 140 includes memory 144, which may comprise volatile and nonvolatile memory such as read-only and/or random-access memory (RAM and ROM), EPROM, EEPROM, flash cards, or any memory common to computing platforms. Further, memory 144 may include one or more flash memory cells, or may be any secondary or tertiary storage device, such as magnetic media, optical media, tape, or soft or hard disk.

Further, computing platform 142 also includes processor 142, which may be an application-specific integrated circuit (“ASIC”), or other chipset, processor, logic circuit, or other data processing device. Processor 142 or other processor such as an ASIC may execute an application programming interface (“API”) layer (not shown in FIG. 2) that interfaces with any resident programs stored in the memory 144 of the mobile communication device 104.

Processor 142 includes various processing subsystems (not shown in FIG. 2) embodied in hardware, firmware, software, and combinations thereof, that enable the functionality of mobile communication device 104 and the operability of the mobile communication device 104 on a wireless network. For example, processing subsystems allow for initiating and maintaining communications, and exchanging data, with other networked devices. For the disclosed embodiments, processing subsystems of processor 142 may include any subsystem used in conjunction with the modules, applications, components and the like herein described.

The computing platform 140 of mobile communication device 104 includes communication module 146 that is operable to receive a URL 118 associated with the user interaction session implemented on the ATM 102. The communication module 146 is configured to implement a communication mechanism that is aligned with the communication mechanism implemented by the ATM 102. For example, the communication module may implement NFC, Bluetooth®, zigbee, RFID, 802.11/Wirless Local Area Network (WLAN) communication or the like, if the corresponding communication mechanism is implemented by the ATM 102. In addition, the computing platform 140 may include an image capture device 150 and the memory 144 store requisite image recognition/decode logic 152 in the event the ATM communication module 116 is configured to implement a visually readable coded, such as bar code, Quick Response (QR) code, Secure Quick Response (SQR) code or the like, as the means by which the URL 118 is communicated to the mobile communication device 104.

In those embodiments of the invention in which the communication from the ATM 102 includes a URL 118 associated with an offer 124, upon receipt of the communication by the device 104, the URL 118 may be configured to be automatically activated or user-activated. Activation of the URL 118 is operable to provide network access to the offer 124, such a coupon, discount or the like. Once the offer has been accessed, the user/customer may select the offer to download the offer 124 to an offer database 154 stored in the memory 144 of the mobile communication device 104 or remotely stored and accessible to the mobile communication device 104. Downloading and storing the offer 124 provides for subsequent use of the offer at a later point in time.

In those embodiments of the invention in which the communication from the ATM 102 includes a URL 118 associated with financial institution contact information 130, upon receipt of the communication by the device 104, the URL 118 may be configured to be automatically activated or user activated. Activation of the URL 118 is operable to provide network access to the financial institution contact information 130. For example, if the URL 118 is associated with a contact telephone number, activation of the URL 119 may provide for automatically dialing the telephone number or the mobile communication device 104 for the purpose of initiating a contact telephone call. In another example, if the URL 118 is associated with a video chat session, activation of the URL 118 may provide for automatically dialing the initiating the vide chat with a contact representative on the mobile communication device 104. In a still further example, if the URL 118 is associated with a contact information webpage, activation of the URL 118 may provide for network accessing of the associated webpage/website.

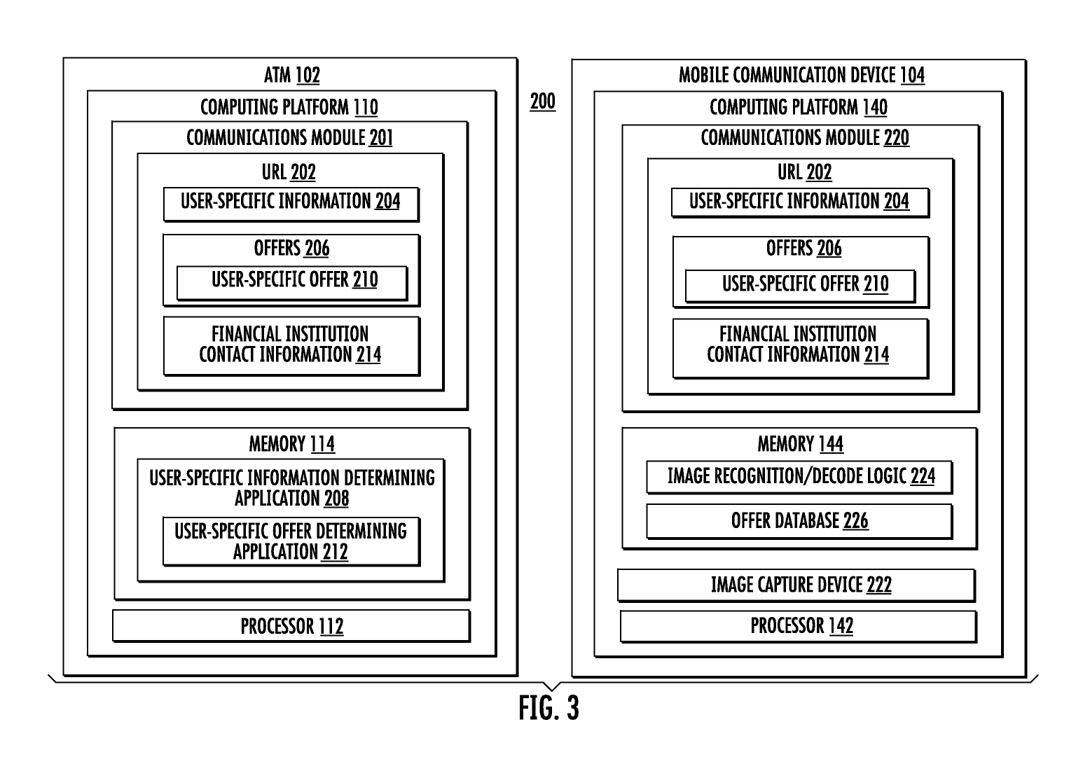

FIG. 3 is a block diagram of a system 100 configured for seamlessly transferring user/customer interaction sessions from an ATM 102 to a mobile communication device 104, in accordance with embodiments of the present invention. The ATM 102 and mobile communication device 104 are similar to those shown and described in relation to FIG. 2. The ATM 102 includes a computing platform 110 having at least one processor 112 and a memory 114 in communication with the processor 112, similarly the mobile communication device 104 includes a computing platform 140 having at least one processor 142 and a memory 144 in communication with the processor 142. Specifics concerning the processors 112 and 142 and the memory 114 and 144 are described above with respect to the discussion if FIG. 2.

In specific embodiments of the invention, the computing platform 110 of ATM 102 includes communication module 202 that is operable to provide secure wireless communication to facilitate the transfer of a user/customer interaction session from the ATM 102 to the mobile communication device 104. In specific embodiments of the invention, the communication module 202 may include Near Field Communication (NFC) Module 204. NFC is a set of short range wireless communication technologies that generally require a distance of 4 centimeters or less. The close range communication that is provided by NFC results in the inability to sniff or otherwise intercept the information associated with the transfer of the user/customer interaction session, such as user/customer authentication credentials, a Uniform Resource Locator (URL) associated with the interaction session or the like.

In addition, NFC module 204 may include security standards 206 that define a protocol stack, such as NFC-SEC or the like, that enables application-independent encryption functions on the data layer, on top of the NFC protocol layer. As such, in addition to providing close range wireless communication, NFC provides for a cryptographically secured protocol, such that session transfer information 212 associated with the transfer of the user/customer interaction session, such as, a Uniform Resource Locator (URL) 214, user/customer authentication credentials 218, session accessing-application activation instructions 216, or other information 220 may be communicated as encrypted data and subsequently decrypted at the mobile communication device 104.

In other embodiments of the invention, communication module 202, or a portion thereof, may be stored in memory 114. In specific such embodiments, communication module 202 may include a Short Message Service (SMS) module 208 that is operable to communicate information to the mobile communication device 104 for the purpose of initiating the transfer of the user/customer interaction session from the ATM 102 to the mobile communication device 104. For example, upon the user/customer providing the requisite input to request a session transfer, a SMS communication (i.e., text message) may be automatically generated and communicated to the mobile communication device 104. In such embodiments the SMS communication may include a session transfer information 212, such as a URL 214 that provides network access to the session, session accessing-application activating instructions 216 (e.g., instructions for activating a mobile banking application) or other information 220. In specific embodiments of the invention, the SMS module 208 may include security standards 210 that define a protocol stack that enables encryption functions on the data layer, on top of the SMS protocol layer. In such embodiments of the invention, the session transfer information 212 included in the communicated SMS message, such as, a URL 214, session accessing-application activating instructions 216, user/customer authentication credentials 218 or other information 220, may be communicated as encrypted data and subsequently decrypted at the mobile communication device 104. In other embodiments, in which the information included in the SMS message is not encrypted or otherwise coded, the transfer process may be configured to provide for the user/customer to mandatorily or optionally re-enter authentication credentials.

Additionally, the memory 114 of ATM 102 includes a plurality of user/customer interaction applications 222, each interaction application 222 is associated with an interaction/activity that the user/customer may conduct on the ATM 102. For example, interaction applications 222 may include, but are not limited to, deposit/withdrawal transactions, investment transactions, account transfers, product/account enrollment, product/account demonstrations, and the like. As previously noted in certain embodiments of the invention, the financial institution or other entity in control of the ATM may configure the interaction applications 222 such that all of applications can be transferred to the mobile communication device 104 or, alternatively, a predetermined portion of the interaction applications 222 may be configured to be transferred to the mobile communication device.

Each of the interaction applications 222 or a designated portion of the interaction applications 222 may include identifiers and/or instructions for the user/customer to recognize the transfer functionality during an interaction session and instructions on how to proceed with implementing the transfer of the interaction session. For example, in those embodiments in which NFC is implemented as the communication mechanism for transfer of the interaction session, the instructions may provide for identifying the “hot spot” on the ATM 102 to which the mobile communication device 104 must be tapped or come into close range proximity in order for the communication/transfer to occur. In other embodiments in which other forms of secure communication are implemented the instructions may provide for the “touch” an identified area of a touch-screen display or enter a designated keystroke on the keypad.

In specific embodiments of the invention, the transfer identifier or instructions may appear within an interaction session if the user/customer has exceeded a predetermined time threshold for completing the interaction session or completely a portion of the interaction session, such that designated portions of the interaction are associated with individual predetermined time thresholds. By providing the transfer identifier or instructions when the user/customer has exceed the time threshold, it may be apparent that the user/customer is taking more time to complete the interaction session or a portion of the session than is typically needed or that the activity, transaction or the like associated interaction session is one that generally takes more time to complete.

In specific embodiments of the invention, the computing platform 140 of wireless communication device 104 includes communication module 224 that is operable to receive secure wireless communication to facilitate the transfer of an interaction session from the ATM 102 to the mobile communication device 104. In specific embodiments of the invention, the communication module may include Near Field Communication (NFC) module 226. The NFC module 226 is operable, when the mobile communication device 104 is positioned in close proximity to the ATM 102, to receive NFC communication communicated from the ATM 102. The NFC communication includes session transfer information 212 associated with the transfer of the interaction session, such as Uniform Resource Locator (URL) 214, user/customer authentication credentials 218, session accessing-application activation instructions 216, or other information 220.

In addition, NFC module 226 may include security standards 228 that define a protocol stack, such as NFC-SEC or the like, that enables application-independent decryption functions on the data layer, on top of the NFC protocol layer. As such, NFC communicated encrypted information such as session transfer information 212 associated with the transfer of the user/customer interaction session, e.g., a Uniform Resource Locator (URL) 214, session accessing-application activation instructions 216, user/customer authentication credentials 218, or other information 220 may be subjected to decryption prior to implementing the information to access the interaction session.

In other embodiments of the invention, communication module 224, or a portion thereof, may be stored in memory 144. In specific such embodiments, communication module 224 may include a Short Message Service (SMS) module 230 that is operable to receive information communicated from the ATM 102 for the purpose of initiating the transfer of the user/customer interaction session from the ATM 102 to the mobile communication device 104. For example, an SMS message (i.e., text message) may include session transfer information 212, for example, a URL 214 that provides network access to the session, session accessing-application activation instructions 216, user/customer authentication credentials 218, or other information 220. In specific embodiments of the invention, the SMS module 230 may include security standards 232 that define a protocol stack that enables decryption functions on the data layer, on top of the SMS protocol layer. As such, SMS communicated encrypted information such as information associated with the transfer of the user/customer interaction session, e.g., user/customer authentication credentials, a Uniform Resource Locator (URL) or the like may be subjected to decryption prior to implementing the information to access the interaction session. In other embodiments, in which the information included in the SMS message is not encrypted or otherwise coded, the transfer process may be configured to provide for the user/customer to mandatorily or optionally re-enter authentication credentials.

Additionally, the memory 142 of mobile communication device 104 may include an interaction session-providing application 234, such as mobile banking application, which may automatically be activated based on receipt of the secure communication from the ATM 102, such as an NFC communication, SMS communication or the like, which is configured to include information for automatically activating such an application. In such embodiments of the invention, activation of the interaction session-providing application 234, such as a mobile banking application, may be operable to automatically continue the interaction session on the mobile communication device 104. Additionally, the information included in the secure communication from the ATM 102 may include the user/customer authentication credentials 218 used to initiate the session on the ATM 102, such that the credentials are automatically applied to the transferred session for the purpose of not requiring the user/customer to re-authenticate (i.e., re-enter the authentication credentials) upon launching the interaction session-providing application 216 and continuing the interaction session on the mobile communication device 104. In addition, the information included in the secure communication from the ATM 102 may include an interaction session bookmark that is operable to provide the interaction session-providing application 234 with information related to where the user/customer concluded the interaction session on the ATM 102, so that the interaction session may be continued on the mobile communication device at or proximate to the location in the session at which the user/customer concluded.

In alternate embodiments of the invention, the session transfer information 212 included in the secure communication from the ATM 102 may include a Uniform Resource Locator (URL) 214 that provides a link to the interaction session. In such embodiments, the URL 214 may be activated upon receipt of the secure communication to provide network access to the continuation if the interaction session. In those embodiments in which the secure communication includes a URL 214, the communication may additionally include the user/customer authentication credentials 218 used to initiate the session on the ATM 102, such that the credentials 218 are automatically applied when activating the URL 214 for the purpose of not requiring the user/customer to re-authenticate (i.e., re-enter the authentication credentials) upon activating the URL 214 and continuing the interaction session on the mobile communication device 104.

Additionally, while in many instances the user/customer may desire to continue the interaction session on the mobile communication device 104 relatively contiguously with conclusion of the interaction session on the ATM 102; however, in other instances the user/customer may desire to continue the interaction session at a later point in time. In such instances, the interaction session transfer process may be configured to store the URL 214 or other session transferring information 220, on the mobile communication device or accessible to the mobile communication device for the purpose of having the user/customer, at their discretion, access and activate the URL 214 or other session transferring information 220 at a later point in time. The system may be configured, by the user/customer or otherwise, such that storage of the URL 214 or other session transfer information 220 is automatic upon receipt, such that the user/customer is required to provide an input to access the transferred interaction session, or the system may be configured to store the URL 214 or other session transfer information 220 based on user/customer request.

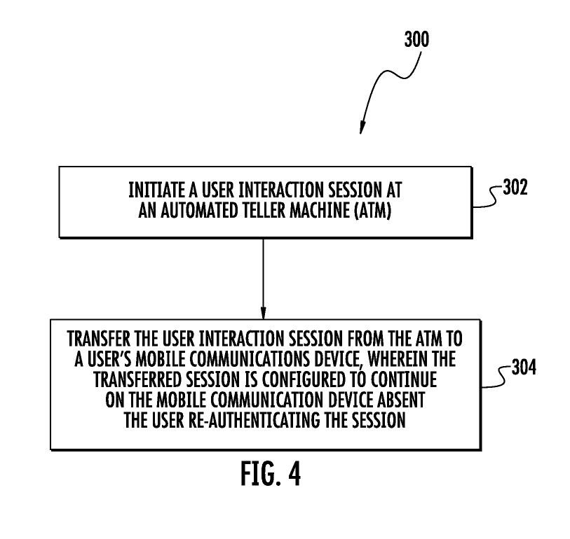

FIG. 4 is a flow diagram of a method 300 configured for communicating, from an ATM 102 to a mobile communication device 104, a Uniform Resource Locator (URL) that provides access to information associated with user interaction session implemented at the ATM 102, in accordance with embodiments of the present invention. At Event 302, a user interaction session is initiated at an Automated Teller Machine (ATM). As previously noted, the ATM may include a conventional ATM, a Video Teller Machine (VTM), a kiosk or any other automated computing device configured to provide financial institution transactions, activities, experiences or the like. The user interaction session may include bill-pay transactions, account transfers, investment transactions, product/account enrollments, user experiences, such as video chat session or the like.

At Event 304, a Uniform Resource Locator that provides access to information associated with the user interaction session is communicated from the ATM to a user's mobile communication device. In further embodiments the method may include automatically activating the URL, upon receipt by the user's wireless communication device, to provide the network access to the information.

The communication of the URL may be implemented by Near Field Communication (NFC), Bluetooth®, Short Message Service (SMS), zigbee, 802.11, a visually readable code, such as bar code, Quick Response (QR) code Secure Quick Response (SQR) code or any other known or future known wireless communication technique.

In specific embodiments of the invention the method further comprises determining user-specific information based on user inputs received during the user interaction session and/or user profile data, such as historical transaction data or the like, retrieved during the user interaction session.

In those embodiments of the method in which the information associated with the URL is an offer, coupon, discount or the like, the user-specific information may be a user-specific offer, coupon, discount or the like. Once the offer or user-specific offer is accessed, the method may further include receiving a user input at the mobile communication device that is operable to download the offer to store the offer in mobile communication device memory or memory accessible to the mobile communication device.

In other embodiments of the invention, the information associated with the URL is financial institution contact information, such as a contact information web page/web site, a video chat session, a telephone number or the like.

Thus, further details are described above for methods, apparatus and computer-program products that provide for wirelessly communicating information from an ATM to a customer's mobile communication device during or proximate in time with the customer's ATM interaction session. More specifically, the information is accessible to the customer through communication of a Uniform Resource Locator (URL) that is wirelessly communicated from the ATM to the customer's mobile communication device. In specific embodiments, the URL may be associated with customer-specific information that is determined, on-the fly during the ATM interaction session, based on customer inputs during the session and/or customer profile data, including transaction history data. In other specific embodiments, the URL may be associated with financial institution contact information, such that the customer may obtain answers to questions related to the ATM interaction session or any other financial institution-related matter using a different channel other than the ATM, specifically their mobile communication device.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A method, comprising:
initiating a user interaction session at an Automated Teller Machine (ATM); and
communicating, from the ATM to a user's mobile communication device during or proximate in time with the user interaction session, a Uniform Resource Locator (URL) that provides network access to information associated with the user interaction session.

2. The method of claim 1, further comprising determining user-specific information based on user inputs received during the user interaction session and wherein communicating further comprises communicating, from the ATM to the user's mobile communication device during or proximate in time with the user interaction session, the URL that provides network access to the user-specific information.

3. The method of claim 1, further comprising determining user-specific information based on retrieved user profile data and wherein communicating further comprises communicating, from the ATM to the user's mobile communication device during or proximate in time with the user interaction session, the user-specific information.

4. The method of claim 1, further comprising receiving, at the ATM during the user interaction session, a user input that requests the information.

5. The method of claim 1, further comprising automatically activating the URL, upon receipt by the user's mobile communication device, to provide network access to the information.

6. The method of claim 1, wherein communicating further comprises communicating, from the ATM to a user's mobile communication device during or proximate in time with the user interaction session, the URL that provides network access to the information, wherein the information is associated with an offer.

7. The method of claim 6, wherein communicating further comprises communicating, from the ATM to a user's mobile communication device during or proximate in time with the user interaction session, the URL that provides network access to the information, wherein the information is associated with a user-specific offer.

8. The method of claim 6, further comprising selecting, at the mobile communication device, the accessed offer to store the offer in mobile communication device memory.

9. The method of claim 1, wherein communicating further comprises communicating, from the ATM to a user's mobile communication device during or proximate in time with the user interaction session, the URL that provides network access to the information, wherein the information is associated with financial institution contact information.

10. The method of claim 1, wherein communicating further comprises communicating, from the ATM to a user's mobile communication device during or proximate in time with the user interaction session, information associated with the user interaction session, wherein communicating is implemented by one of Near Field Communication (NFC), Bluetooth®, zigbee or 802.11 wireless protocol.

11. The method of claim 1, wherein communicating further comprises:
presenting a visually readable code on a display associated with the ATM, wherein the code includes the URL that provides access to the information; and
capturing the code with the mobile communication device.

12. The method of claim 11, wherein presenting the visually readable code further comprises presenting one of a bar code, a Quick Response (QR) code, or Secure Quick Response (SQR) code.

13. A system, comprising:
an Automated Teller Machine (ATM) including a first computing platform having a first memory and a first processor in communication with the first memory, wherein the first processor is configured to initiate a user interaction session and communicate, during or proximate in time with the user interaction session, a Uniform Resource Locator (URL) that provides network access to information associated with the user interaction session; and
a mobile communication device including a second computing platform having a second memory and a second processor in communication with the second memory, wherein the second processor is configured to receive the URL from the ATM during or proximate in time with the user interaction session.

14. The system of claim 13, wherein the first processor of the ATM is further configured to determine user-specific information based on user inputs received during the user interaction session and communicate, during or proximate in time with the user interaction session, the URL that provides network access to the user-specific information.

15. The system of claim 13, wherein the first processor of the ATM is further configured to determine user-specific information based on retrieved user profile data and communicate, during or proximate in time with the user interaction session, the URL that provides network access to the user-specific information.

16. The system of claim 13, wherein the first processor of the ATM is further configured to receive, at the ATM during the user interaction session, a user input that requests the information.

17. The system if claim 13, wherein the second processor of the mobile communication device is further configured to automatically activate the URL, upon receipt, to provide network access to the information.

18. The system of claim 13, wherein the first processor of the ATM is further configured to communicate, during or proximate in time with the user interaction session, the URL that provides network access to the information, wherein the information is associated with an offer.

19. The system of claim 18, wherein the first processor of the ATM is further configured to communicate, during or proximate in time with the user interaction session, the URL that provides network access to the information, wherein the information is associated with a user-specific offer.

20. The system of claim 13, wherein the second processor of the mobile communication device is further configured to select the accessed offer to store the offer in mobile communication device memory.

21. The system of claim 13, wherein the first processor of the ATM is further configured to communicate, during or proximate in time with the user interaction session, the URL that provides network access to the information, wherein the information is associated with financial institution contact information.

22. The system of claim 13, wherein the first processor of the ATM is further configured to communicate, during or proximate in time with the user interaction session, information associated with the user interaction session, wherein communicating is implemented by one of Near Field Communication (NFC), Bluetooth®, zigbee or 802.11 wireless protocol.

23. The system of claim 13, wherein the first processor of the ATM is further configured to present a visually readable code on a display associated with the ATM, wherein the code includes the URL that provides access to the information and the mobile communication device includes an image capture component that operates in conjunction with the second processor to capture the code.

24. The system of claim 13, wherein the first processor of the ATM is further configured to present a visually readable code further comprises presenting one of a bar code, a Quick Response (QR) code, or Secure Quick Response (SQR) code.

25. A computer program product, comprising:
a non-transitory computer-readable medium comprising:
a first set of codes for causing a computer to initiate a user interaction session at an Automated Teller Machine (ATM); and
a second set of codes for causing a computer to communicate, from the ATM to a user's mobile communication device during or proximate in time with the user interaction session, a Uniform Resource Locator (URL) that provides network access to information associated with the user interaction session.

26. The computer program product of claim 25, further comprising a third set of codes for causing a computer to determine user-specific information based on user inputs received during the user interaction session and the second set of codes is further configured to cause the computer to communicate, from the ATM to the user's mobile communication device during or proximate in time with the user interaction session, the URL that provides network access to the user-specific information.

27. The computer program product of claim 25, further comprising a third set of codes for causing a computer to determine user-specific information based on retrieved user profile data and wherein the second set of codes is further configured to cause the computer to communicate, from the ATM to the user's mobile communication device during or proximate in time with the user interaction session, the user-specific information.

28. The computer program product of claim 25, further comprising a third set of codes for causing a computer to receive, at the ATM during the user interaction session, a user input that requests the information.

29. The computer program product of claim 25, further comprising a third set of codes for causing a computer to automatically activate the URL, upon receipt by the user's mobile communication device, to provide network access to the information.

30. The computer program product of claim 25, wherein the second set of codes is further configured to cause the computer to communicate, from the ATM to a user's mobile communication device during or proximate in time with the user interaction session, the URL that provides network access to the information, wherein the information is associated with an offer.

31. The computer program product of claim 30, wherein the second set of codes is further configured to cause the computer to communicate, from the ATM to a user's mobile communication device during or proximate in time with the user interaction session, the URL that provides network access to the information, wherein the information is associated with a user-specific offer.

32. The computer program product of claim 30, further comprising a third set of codes for cause a computer to receive, at the mobile communication device, a user selection of the accessed offer, wherein selection provides for storing the offer in mobile communication device memory.

33. The computer program product of claim 25, wherein the second set of codes is further configured to cause the computer to communicate, from the ATM to a user's mobile communication device during or proximate in time with the user interaction session, the URL that provides network access to the information, wherein the information is associated with financial institution contact information.

34. The computer program product of claim 25, wherein the second set of codes is further configured to cause the computer to communicate, from the ATM to a user's mobile communication device during or proximate in time with the user interaction session, information associated with the user interaction session, wherein communicating is implemented by one of Near Field Communication (NFC), Bluetooth®, zigbee or 802.11 wireless protocol.

35. The computer program product of claim 25, wherein the second set of codes is further configured to cause the computer to present a visually readable code on a display associated with the ATM, wherein the code includes the URL that provides access to the information.

36. The computer program product of claim 25, wherein the second set of codes is further configured to present the visually readable code, wherein the code includes one of a bar code, a Quick Response (QR) code, or Secure Quick Response (SQR) code.
